(19) United States
(12) Patent Application Publication
(10) Pub. No.: US 2017/0091382 A1
(43) Pub. Date: Mar. 30, 2017

(54) SYSTEM AND METHOD FOR AUTOMATING DATA GENERATION AND DATA MANAGEMENT FOR A NEXT GENERATION SEQUENCER

(71) Applicant: YOTTA BIOMED, LLC., Bethesda, MD (US)

(72) Inventors: Sijung YUN, Bethesda, MD (US); Joshua SHALLOM, Bethesda, MD (US)

(73) Assignee: YOTTA BIOMED, LLC., Bethesda, MD (US)

(21) Appl. No.: 14/869,103

(22) Filed: Sep. 29, 2015

(51) Int. Cl. G06F 19/22

(52) U.S. Cl. CPC G06F 19/22

(57) ABSTRACT

A web-based server/cloud computing system for a next generation sequencer (NGS) to integrate data generation, data analysis and data management. When a user intends to sequence a biological sample, the user is asked to login to the NGSinForm, select and submits sets of software analysis bioinformatics programs, which schedules the sequencing, quality control, data analysis and management of that data, all done simultaneously and sequentially. When the sequencing is completed, the raw sequence data is uploaded to a server or cloud, raw data is analyzed, following the analysis preferences. Finally, all data generated will be saved and managed systematically. Hence, a user is able to access the information on the sample as well as the analyzed data anytime and anywhere with a one-time submission of the single web form—NGSinForm—even before starting the sequencing.

### FIELD OF INVENTION

This invention relates to a web based system, particularly to the data generation, targeted data analysis and management of a next generation sequencer (NGS) and all of the data generated. This system is hereafter referred to as the NGSinForm (full name: Next Generation Sequencing in Form).

### BACKGROUND

Next generation sequencers (NGS) have revolutionized the sequencing of any genome (DNA-seq), transcriptome (RNA-seq) or protein-DNA interactions (ChIP-Seq). These NGS machines generate large amounts of data which is stored in hard-drives, servers and now also in clouds. Data is being generated at the rate of almost 300 GB per genome sequenced, and is then stored and saved faster than it can be analyzed by the very same researchers generating this massive amounts of data. Though there are many NGS analysis software available they are not directly linked to the NGS machines producing this data.

### SUMMARY

The present invention, NGSinForm, is a web based automated system for a next generation sequencer to achieve automatic data generation, post-sequencing analysis and systematic data management. In one embodiment, this web-based server/cloud computing system enables a user to schedule use of the sequencer, save information on a sample for sequencing, perform targeted automated data analysis, and management of that data.

### BRIEF DESCRIPTION OF THE DRAWINGS

FIG. 1 shows a system comprising the NGS machine, its control computer, server/cloud and the connection to the internet. The server includes a SQL server and a firewall;

FIG. 2 shows the portal pages connected through the control center of the NGS machine. The first entry portal page is where the user logs in and then chooses between the two options on the screen, Data Access or Data Generation. Usually the first choice is “Data Generation” (once data has been generated, then “Data Access” will be populated for use). The Data Generation option opens a new second page, where one of four choices that need to be completed and submitted;

FIG. 3 shows a screenshot of the data analysis NGSinform that gives the user two options: Data Access or Data Generation;

FIG. 4 shows a screenshot of the Data Access option page. The columns show the Library, Experiment type, Date data was Created, Date data was Processed, Date data was Completed, its present state (processed/completed), and the Researcher details associated with this Data;

FIG. 5 shows a screenshot of the four Data Generation options: DNA-seq, RNA-seq, ChIP-seq and Special sequencing;

FIG. 6 shows a screenshot of the “basic information” for the RNA-seq choice, which when completed and submitted opens the next screen;

FIG. 7 shows a screenshot of the “experimental information” that needs to be completed and submitted in the RNA-seq NGSinForm;

FIG. 8 shows a screenshot of the “bioinformatics information” that needs to be completed and submitted for the RNA-seq choice, which when submitted opens the next screen;

FIG. 9 shows a screenshot of the “confirm information” (composite of basic, experimental and bioinformatics choices) that were completed earlier and will now be submitted in the RNA-seq NGSinForm;

FIG. 10 shows a screenshot of the ChIP-seq choice, “basic information”, which when submitted opens the next screens, “experimental information”, “bioinformatics information” and finally “confirm information”;

FIG. 11 shows a screenshot of the DNA-seq choice, “basic information”, which when completed and submitted opens up the next screens, “experimental information”, “bioinformatics information” and finally “confirm information”;

FIG. 12 shows a screenshot of the Special sequencing, “basic information” (rare sequencing that are used less often) choice, which when submitted opens the next screen “experimental information”, “bioinformatics information” and finally “confirm information” (this “basic information” option will include miRNA-seq, lincRNA-seq, methylation-seq, etc.).

### DETAILED DESCRIPTION OF INVENTION

A Next Generation Sequencing (NGS) machine is connected to a control center (a computer) and a server or a cloud (where the information is stored). In most cases, this server/cloud is also connected to the internet. A NGS machine generates raw data or sequences and that completes its job or run. Our invention adds another automated feature to the machine that will continue to analyze the sequence data generated. Hence, our invention will get the user in advance to specify the analysis (and hence predetermined bioinformatics programs) that needs to be run, once the NGS machine has completed its primary task of sequencing. Our invention, NGSinForm, will allow users to track their samples all along the sequencing and data analysis pipeline of their own choosing.

A code has been written in the language html/php to display normal text on a web page, options to choose from. These are options that the user wants to perform on the raw or sequence data. This web page is the first or portal entry page. When the user chooses one of the options, s/he is taken to the next or second web page which is a web page that has multiple specific details about the sample that is being submitted and the bioinformatics programs that need to be run on the sample, post-sequencing. All the options are visible, the user needs to choose and submit his/her choices. Once the choices have been made and submitted, the NGS machine and related programs start their run and bioinformatics analysis. All choices are also saved and accessible indefinitely in a very systematic way.

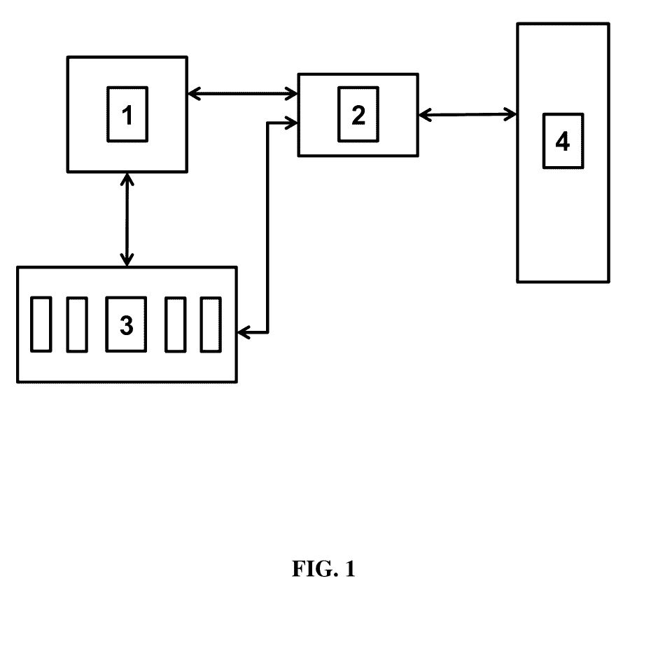

FIG. 1 shows the Next Generation Sequencing machine (NGS) 1, connected to its control center, monitor and keyboard 2, which are both connected to a high capacity server 3. The server includes a SQL server and is protected by a firewall that allows only known users to access the system through a username and password (The server could also be in the cloud, viz. may not have a physical presence next to the NGS machine). The control center controls the working of the NGS machine, its server or cloud and a connection to the internet 4. All commands are generated from the control center 2. In the first step, commands are given to start and carry out the sequencing of the biological sample. This is done in the NGS machine 1 and all sequence data generated are saved in the server 3. In the second step, once sequencing of the biological sample is completed, our novel script invokes a predetermined pipeline of bioinformatics programs that are then run on the sequencing data generated by the NGS machine 1. These programs are run in the server/cloud 3. When the bioinformatics programs and runs are completed, this data can be accessed through the internet, via a standard firewall, where data can be accessed and/or downloaded, but cannot be changed or modified.

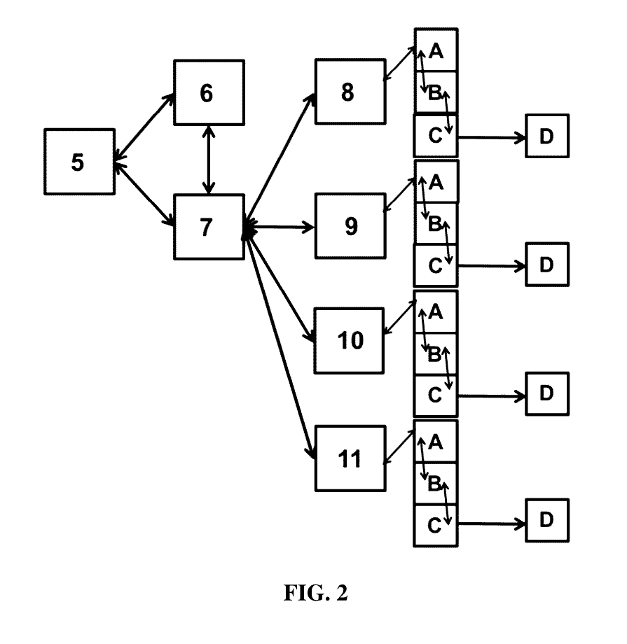

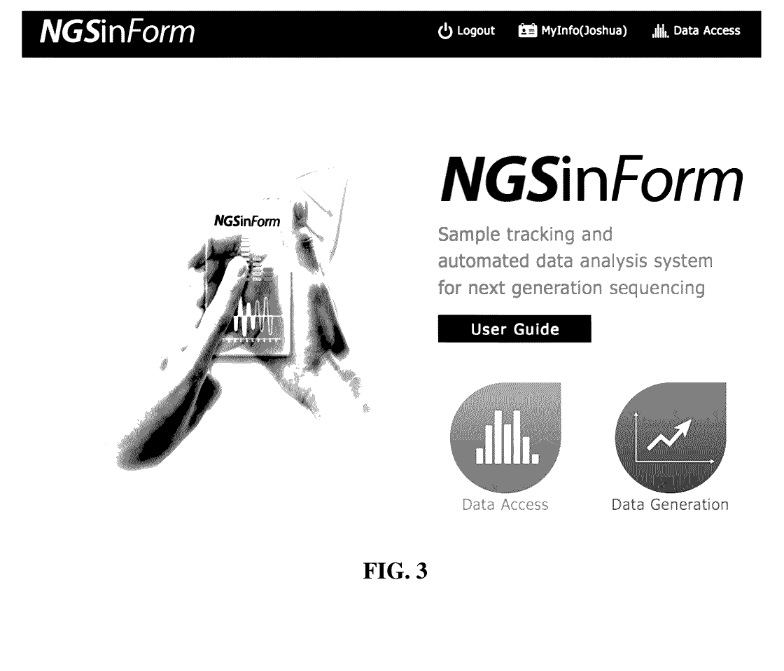

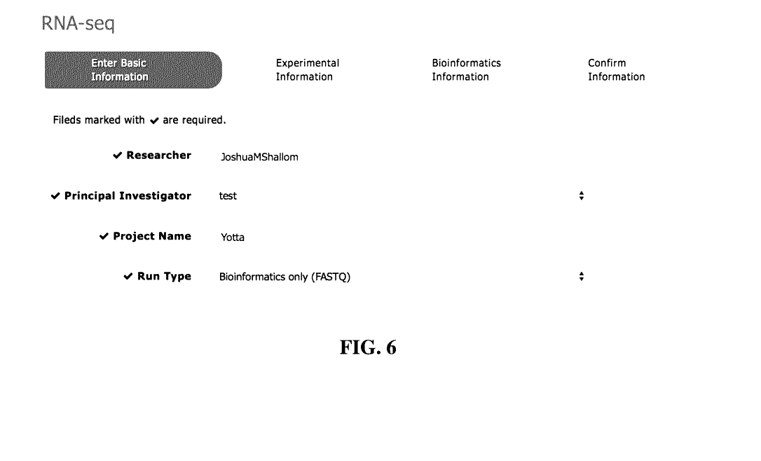

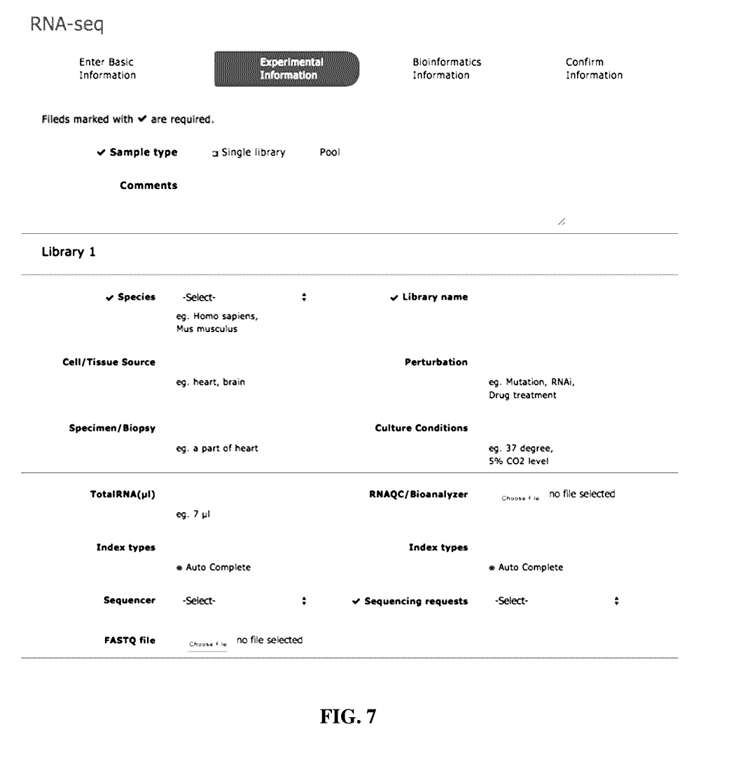

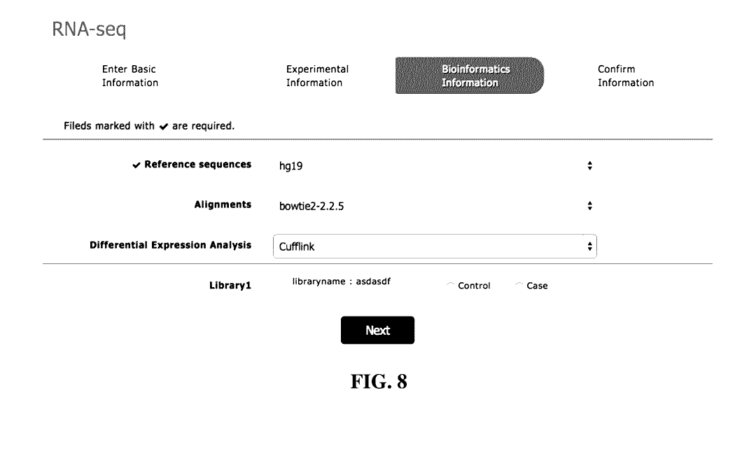

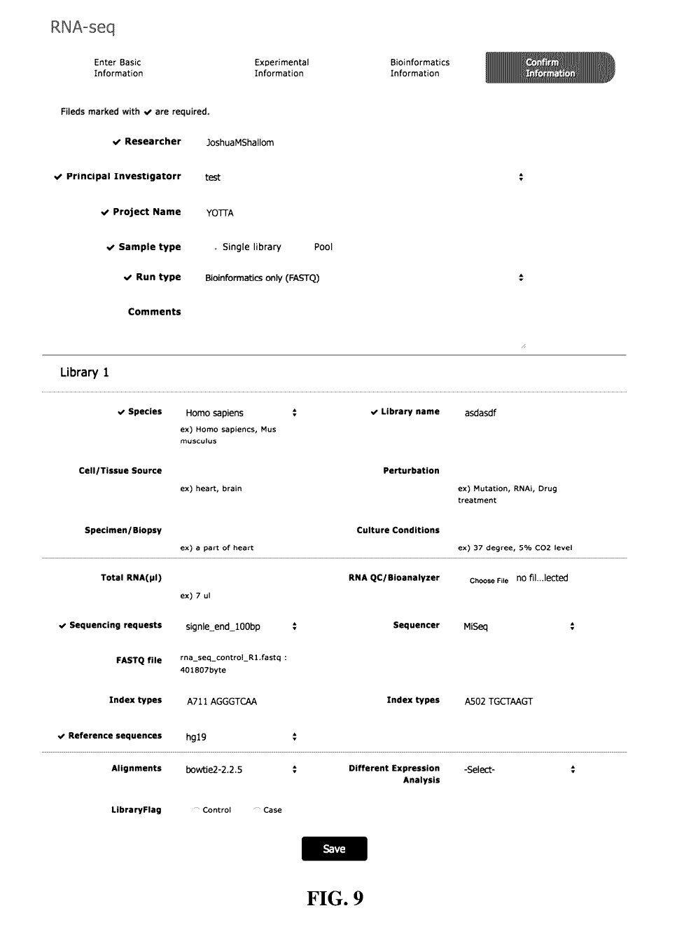

FIG. 2 shows the web pages that have been made. These pages are connected to a SQL server, built into the server 3 shown in the previous figure (FIG. 1). The first page, page number 5 in FIG. 2 and screenshot shown in FIG. 3, is the entry portal page that has two options to choose from, for the user. If option one or Data Access is the choice, page 6 opens up showing the following details about the sample in question: Which library was used, the pool used, when the data was first created, when it was processed (sequenced), when it was completed, its present state (being processed or completed), and finally, the Researcher to whom the data belongs (these fields will be populated only after the first sample has been processed through the second option—Data Generation). If option two or Data Generation (on Page 5) is the choice, page 7 opens (FIG. 5). Page 7 in turn, has four options to choose from: DNA-seq, RNA-seq, ChIP-seq and Special sequencing. If the RNA-seq option is chosen, page 8A opens up (FIG. 6). This page has fields for “basic information”, the name of the Researcher, the name of the Principal Investigator and the Project name. Once these fields are entered and submitted, page 8B opens up (FIG. 7). Page 8B shows a NGSinForm in which all the “experimental information” fields need to be completed and submitted. Once submitted, Page 8C opens up (FIG. 8) that describes the bioinformatics programs that need to be run on the post-sequencing data generated by the NGS machine. The user completes all the fields in the NGSinForm (all fields marked with a ✓ are mandatory), choosing from various drop-down options that are available on the form. Once the user completes and submits the RNA-seq NGSinForm, a “confirm information” (composite of “basic, “experimental” and “bioinformatics” information) page opens up (FIG. 9). Once submitted, this RNA-seq option is started by the NGS machine.

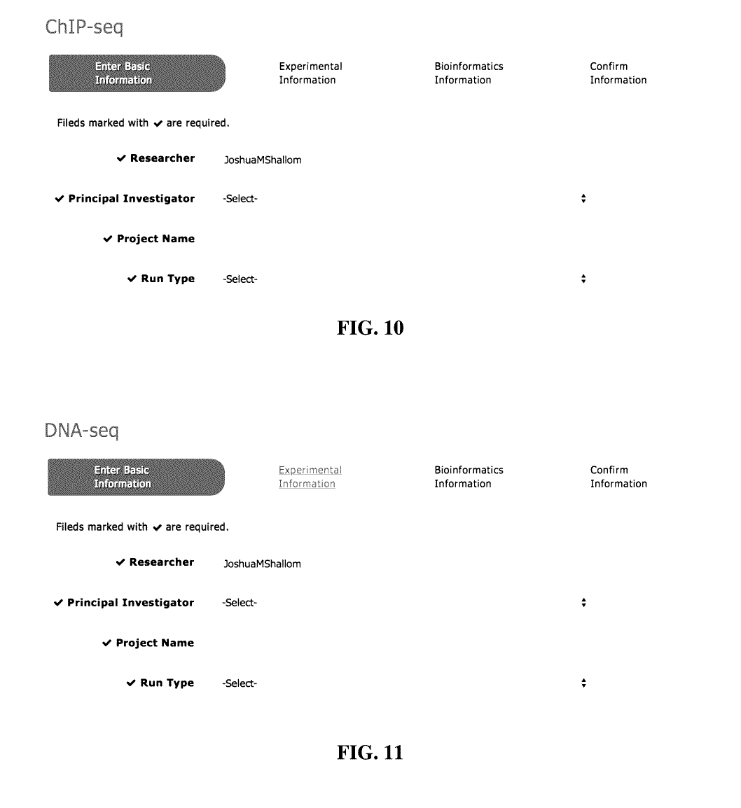

If the ChIP-seq option (on page 7) is the choice, page 9A (FIG. 10) opens up, where “basic information”, Name of the researcher, Principal Investigator and Project name have to be entered and submitted. Page 9B, 9C and 9D, again show “experimental”, “bioinformatics” and “confirm” information (screenshots similar to pages 8B, 8C and 8D respectively, hence not shown) then opens up. Once completed and submitted, the ChIP-seq option is started by the NGS machine.

If the DNA-seq option (on page 7) is the choice, page 10A (FIG. 11) opens up, where “basic information”, Name of the researcher, Principal Investigator and Project name have to be entered and submitted. Page 10B, 10C and 10D, again show “experimental”, “bioinformatics” and “confirm” information (screenshots similar to pages 8B, 8C and 8D respectively, hence not shown) then opens up. Once completed and submitted, the DNA-seq option is started by the NGS machine.

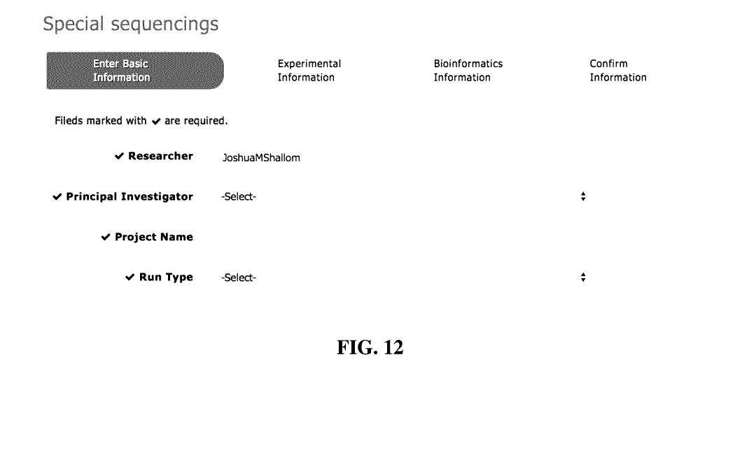

If the Special sequencing option (specialized sequencing is done less frequently and includes miRNA-seq, lincRNA-seq and methylation-seq, on page 7) is the choice, page 11A (FIG. 12) opens up, where “basic information”, Name of the researcher, Principal Investigator and Project name have to be entered and submitted. Page 11B, 11C and 11D, again show “experimental”, “bioinformatics” and “confirm” information (screenshots similar to pages 8B, 8C and 8D respectively, hence not shown) then opens up. Once completed and submitted, the Special sequencing option is started by the NGS machine.

FIG. 3 shows a screenshot of the contents of NGSinForm, the first or portal page. There are two options to choose from: Data Access or Data Generation. Choosing one or the second option has been described in FIG. 2 above.

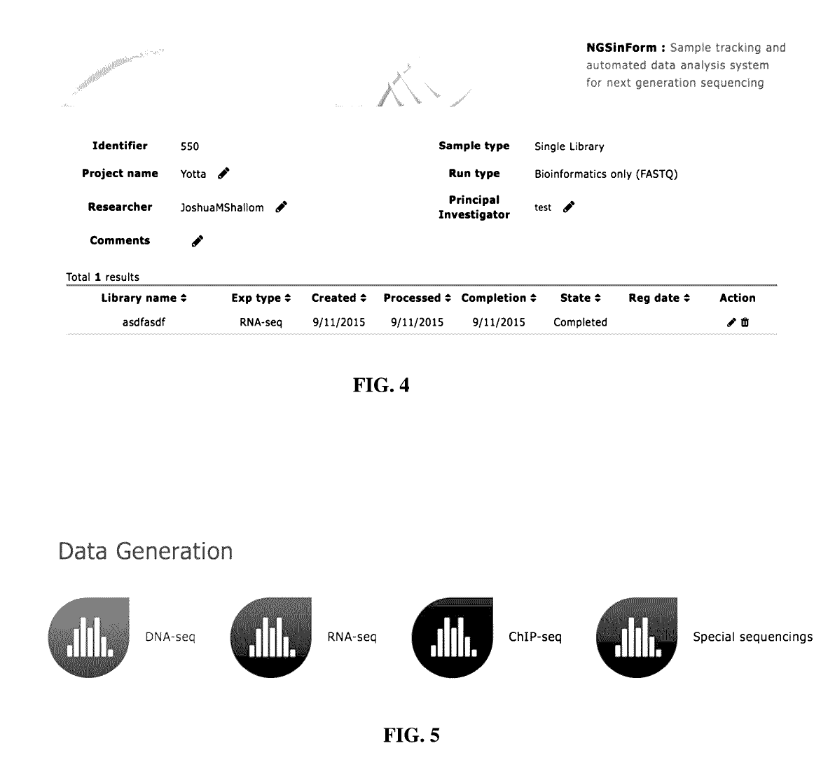

FIG. 4 shows a screenshot of the Data Access page: the library that has been used, the pool, when this data has been created, when it was processed, when it was completed, in what state it is (being processed or is completed) and finally the date it was completed.

FIG. 5 shows a screenshot of the Data Generation page with four options: DNA-seq, RNA-seq, ChIP-seq and Special sequencing.

FIG. 6 shows a screenshot of the RNA-seq “basic information” page if this option has been chosen: the name of the Researcher, the name of the Principal Investigator and the Project name.

FIG. 7 shows a screenshot of the “experimental information” page where all the fields that need to be entered if RNA-seq option has been chosen: sample type, species, library name, cell/tissue source, perturbation, specimen/biopsy, culture conditions, total DNA, QC/Bio analyzer, index type, reference sequence(s), sequencing requests, sequencer details, alignments, variant calling and annotation.

FIG. 8 shows a screenshot of the “bioinformatics information” page, if RNA-seq option has been chosen: the name of the Researcher, the name of the Principal Investigator and the Project name.

FIG. 9 shows a screenshot of the “confirm information” page where all the fields chosen in the earlier pages need to be confirmed here. This page acts as a “are you sure” page to confirm, submit and then start the RNA-sequencing and analysis.

FIG. 10 shows a screenshot of the “basic information” page, if ChIP-seq option has been chosen: the name of the Researcher, the name of the Principal Investigator and the Project name. Once this information is completed and submitted, “experimental information”, “bioinformatics information” and “confirm information” pages open up similar to what was described for RNA-seq earlier, and hence is not described and shown for ChIP-seq.

FIG. 11 shows a screenshot of the “basic information” page where all the fields that need to be entered if DNA-seq option has been chosen: the name of the Researcher, the name of the Principal Investigator and the Project name. Once this information is completed and submitted, “experimental information”, “bioinformatics information” and “confirm information” pages open up similar to what was described for RNA-seq earlier, and hence is not described and shown for DNA-seq.

FIG. 12 shows a screenshot of the “basic information” page, if Special sequencing option has been chosen (special sequencing is the specialized sequencing which is done not-so-often and includes miRNA-seq, lincRNA-seq or methylation-seq): the name of the Researcher, the name of the Principal Investigator and the Project name. Once this information is completed and submitted, “experimental information”, “bioinformatics information” and “confirm information” pages open up similar to what was described for RNA-seq earlier, and hence is not described and shown for Special sequencing.

Special Note: For the sake of clarity and easy flow in the description of all the figures above, we have deliberately not mentioned that each webpage has links to following: explanation of all the fields in that page, details about the company, link to contact the administrator of the website, link to the data access or data generation. In short, one can switch from any page to any page, without having to backtrack.

The Next Generation Sequencing (NGS) machine by itself generates the sequence of a biological sample and nothing more. Though this sequence is significant in itself, it can be used only when the data is modified using further scripts and programs. Hence, any useful data can only be generated when the NGS machine is connected to programs and scripts in a meaningful way. The web server automatically analyzes RNA-seq, ChIP-seq, DNA-seq and Special sequencing data using the bioinformatics programs that a user selected at the time of NGSinForm submission. For DNA-seq, the first step of analysis is the quality check of the raw reads which is in the format of fastq file using FASTQC software. The second step is the sequence alignment. Short read aligners such as BWA or BOWTIE2 are the options to choose from. Next, variant calling is performed using the bioinformatics program GATK or Sarntools. Finally, the variants found are annotated, For example, whether a single nucleotide polymorphism (SNP) leads to any change in the protein coding or not, using the bioinformatics program Annovar. For RNA-seq, quality check and alignment is performed. Since RNA-seq requires splicing: knowing aligners, use of either the bioinformatics programs TOPHAT2 or STAR as an aligner, For ChIP-seq, quality check and alignment with DNA-seq aligners is performed. Thereafter, peak calling is performed using either the bioinformatics program MACS or SICER.

The present invention provides a web-based server/cloud computing system for a next generation sequencer (NGS) to integrate data generation, data analysis and data management. When a user intends to sequence a biological sample, the user is asked to login to the web site. The user provides information on the sample to sequence through a web form called NGSinForm. The user selects a set of software analysis bioinformatic programs that the user has the right to use and parameters to run on the sample. The user then submits the request. The administrator of the sequencing machine and the connected server/cloud, schedules the sequencing, quality control and data analysis and management of that data, all done simultaneously and sequentially, through the website for use of the next generation sequencer. Our NGSinForm, a web-form, is completed by the user to provide detailed information on the sample and the information necessary for automatic data analysis. When the sequencing is completed, the raw sequence data is uploaded to a server or cloud automatically. The raw data is analyzed automatically following the user-provided information on the analysis preferences. Finally, all the data generated will be saved and managed systematically. Hence, a user is able to access the information on the sample as well as the analyzed data anytime and anywhere with a one-time submission of our single web NGSinForm before even starting the sequencing.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. A system for providing an automated connection between a Next Generation Sequencing (NGS) machine and a downstream connection, the system comprising:
a processor configured to execute RNA-seq Bioinformatics programs as post-sequencing for RNA-seq analysis without any manual intervention.

2. The system of claim 1, wherein the processor is configured to execute ChIP-seq Bioinformatics programs as post-sequencing for Chip-seq analysis without any manual intervention.

3. A system for providing an automated connection between a Next Generation Sequencing (NGS) machine and a downstream connection, the system comprising:
a processor configured to execute DNA-seq Bioinformatics programs as post-sequencing for DNA-seq analysis without any manual intervention.

4. The system of claim 1, wherein the processor is configured to execute Special Sequencing Bioinformatics programs as post-sequencing for Special sequencing analysis without any manual intervention.

5. The system of claim 4, wherein the Special sequencing analysis includes analysis of miRNA-seq, lincRNA, methylation-seq or peptide sequencing.

6. The system of claim 1, wherein the processor is configured to keep records of all biological sample data analysis tracking mechanisms to allow users to track data analysis progress and status at each and every time point in a sequencing and analysis procedure.

7. The system of claim 1, wherein the processor is configured to generate a sequence of a biological sample and nothing more such that any data is only generated when the NGS machine is connected to programs and scripts.

8. The system of claim 1, further comprising:
a web server configured to automatically analyze DNA-seq, RNA-seq, ChIP-seq and Special sequencing data using bioinformatics programs that a user selected at the time of submission of a predetermined web page.

9. A method for a sequence analysis, comprising:
performing a quality check of raw reads; and
performing a sequence alignment.

10. The method of claim 9, further comprising:
performing variant calling; and
annotating variants found,
wherein the sequence analysis is DNA-seq analysis.

11. The method of claim 10, wherein the input is in the format of a fastq file.

12. The method of claim 10, wherein the input is in the format of aligned bam file.

13. The method of claim 10, wherein the sequence alignment is performed using short read aligners.

14. The method of claim 10, wherein the variant calling is performed using a bioinformatics program.

15. The method of claim 10, wherein the annotating variants found includes annotating whether a single nucleotide polymorphism (SNP) leads to any change in a protein coding or not, using a bioinformatics program.

16. The method of claim 9, wherein:
the sequence analysis is RNA-seq analysis that includes splicing,
the transcriptomic expression is quantified, and
the differential gene expression analysis is performed.

17. The method of claim 9, wherein:
the sequence analysis is ChIP-seq analysis, and
the alignment is performed with DNA-seq aligners.

18. The method of claim 17, further comprising:
after performing the alignment, perform peak calling using a bioinformatics program.
